(19) United States
(12) Patent Application Publication
(10) Pub. No.: US 2013/0078091 A1
(43) Pub. Date: Mar. 28, 2013

(54) SEALING ARRANGEMENT

(71) Applicant: Paul D. REES, Derby (GB)

(72) Inventor: Paul D. REES, Derby (GB)

(73) Assignee: ROLLS-ROYCE PLC, London (GB)

(21) Appl. No.: 13/614,183

(22) Filed: Sep. 13, 2012

(30) Foreign Application Priority Data
Sep. 28, 2011 (GB) 1116666.7

(51) Int. Cl. F02C 7/06; F02C 7/12; F02C 7/28

(52) U.S. Cl. 415/230; 277/350; 277/301

(57) ABSTRACT

A seal assembly for a bearing chamber of a gas turbine engine. The seal assembly includes a seal land having a sealing surface and a non-sealing surface, and at least one non-contact seal member having a sealing surface and a non-sealing surface. The opposing sealing surfaces define a fluid flow path for a sealing fluid such as air from a compressor of the gas turbine engine. The seal assembly includes a sealing fluid cooling arrangement comprising an oil jet configured to provide cooling oil to one or both of the seal member and the seal runner non-sealing surfaces.

The present disclosure relates to a sealing arrangement.

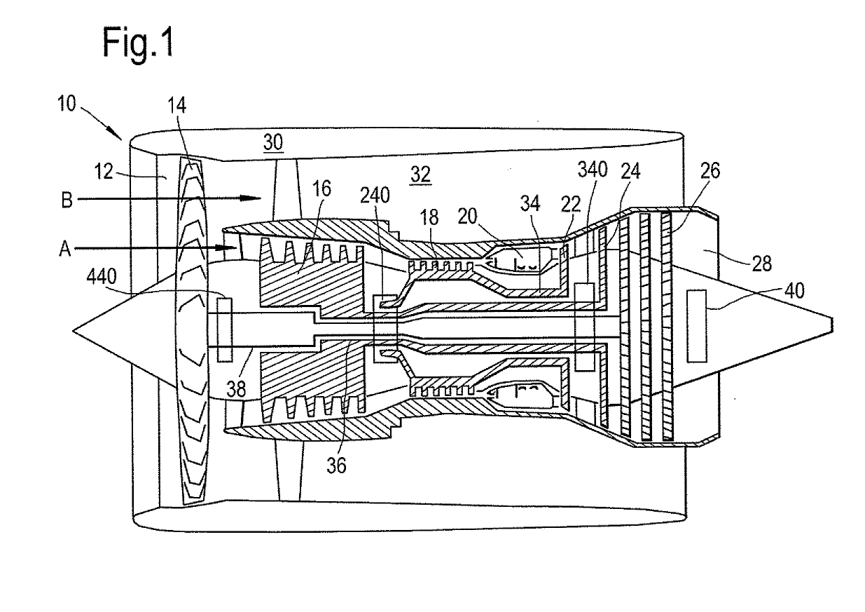

Gas turbine engines include one or more shafts, which rotate relative to fixed components of the engine, or other components of the engine which rotate at different speeds. As illustrated in FIG. 1, in order to facilitate rotation, each shaft 2 is mounted within the engine by one or more bearings 4. The bearings 4 are located within a sealed bearing chamber comprising a housing 6, through which the shaft 2 passes, and which generally contains oil to both lubricate and cool the bearings 4. A clearance must be provided between the shaft 2 and the ends of the housing 6 through which the shaft 2 passes in order to allow rotation of the shaft, and this clearance will require sealing to prevent oil from the bearing chamber escaping and contaminating other parts of the engine.

Various types of seal arrangement may be suitable for sealing the gap. One preferred seal for sealing this gap is a non-contact seal. Non-contact seals provide effective sealing, while producing relatively little frictional losses in operation. One suitable type of non-contact seal is a labyrinth seal, as shown in FIG. 1. Labyrinth seals comprise a plurality of fins 9 arranged in series along a surface of either the shaft 2 or a lip extending inwardly from the end part of the housing 6 with a seal runner being provided at an opposing surface, thereby defining a gap 8 therebetween. Sealing air is supplied to an external side of the seal at a seal inlet 7, and is forced to traverse the series of fins 9 to a seal outlet 5, located on an internal side of the housing 6. A sealing air vent 11 is provided in the housing to vent the sealing air from the housing, and thereby provide a pressure gradient across the seal. The fins 9 generate pressure losses in the sealing air flow, thereby minimising sealing air usage.

The sealing air is generally provided at a relatively high pressure to ensure that oil does not leak through the gap 8 from an internal side of the seal to an external side of the seal. Where the bearing chamber is installed in a gas turbine engine, such high pressure sealing air is generally provided by a compressor stage of the engine core flow.

Recent and projected increases in engine compression ratios may result in high pressure core air at the final high pressure compressor stage having a temperature of up to around 700° C. Such high pressure sealing air may provide a more effective seal in comparison relatively low pressure sealing air. Where lower pressure sealing air is used, this can also be heated by engine core flow to relatively high temperatures. On the other hand however, the high temperature, high pressure sealing air may be hot enough to cause degradation of the oil in the area local to seal outlet 5, and in severe cases, ignition may occur when the high temperature sealing air contacts the oil. The high temperature sealing air can also lead to heating of the seal in use, thereby causing thermal expansion of the seal and/or seal land, thereby degrading seal performance by increasing or reducing the size of the gap beyond acceptable tolerances. The high temperature sealing air may also require the use of different grades of seal abradable lining material which could be harder and likely to cause greater seal fin wear in cases when contact between the fins and the lining material occurs.

The present invention provides a seal arrangement that seeks to address the aforementioned problems.

According to a first aspect of the present invention, there is provided a seal arrangement comprising;

a sealing land having a sealing surface and a non-sealing surface;
at least one non-contact seal member having a sealing surface and a non-sealing surface, the non-contact seal member being spaced apart from the sealing land sealing surface to define a fluid flow path between the seal land sealing surface and seal member sealing surface; and
a sealing air cooling arrangement comprising a fluid spray nozzle configured to provide a cooling fluid jet to one or both of the seal member and the seal runner non-sealing surfaces.

By providing a cooling fluid jet to a non-sealing surface of one of the seal member and the seal runner, the high pressure sealing air flow flowing into the bearing chamber in use is cooled before coming into contact with the bearing chamber environment. Such an arrangement therefore increases the longevity of the bearing oil, thereby reducing engine maintenance requirements. By cooling one of the seal member and seal runner, thermal expansion of the seal components is reduced, thereby maintaining seal clearances within acceptable tolerances.

The sealing land may be provided on a lip which extends inwardly from an end part of a bearing chamber housing, and the seal member may comprise part of a shaft.

The seal member may be provided on a lip which extends inwardly from an end part of a bearing chamber housing, and the seal land may comprise a part of a rotatable shaft. Alternatively, the seal member may be provided on a first rotatable shaft, and the seal land may be provided on a second rotatable shaft provided annularly outwardly of the first rotatable shaft.

The seal assembly may comprise a plurality of spaced seal members, and may comprise a labyrinth seal.

A plurality of fluid spray nozzles may be provided. The or each fluid spray nozzle may be configured to provide an oil jet. The cooling arrangement may comprise an oil reservoir for providing oil for the fluid spray nozzle(s), which oil reservoir may comprise the bearing chamber.

According to a second aspect of the present invention, there is provided a bearing chamber for a gas turbine engine comprising a seal assembly according to the first aspect of the invention.

According to a third aspect of the present invention, there is provided a gas turbine engine comprising a bearing chamber according to the second aspect of the invention.

Examples of the present disclosure will now be described with reference to the accompanying drawings, in which:

FIG. 1 is a sectional side view of a gas turbine engine.

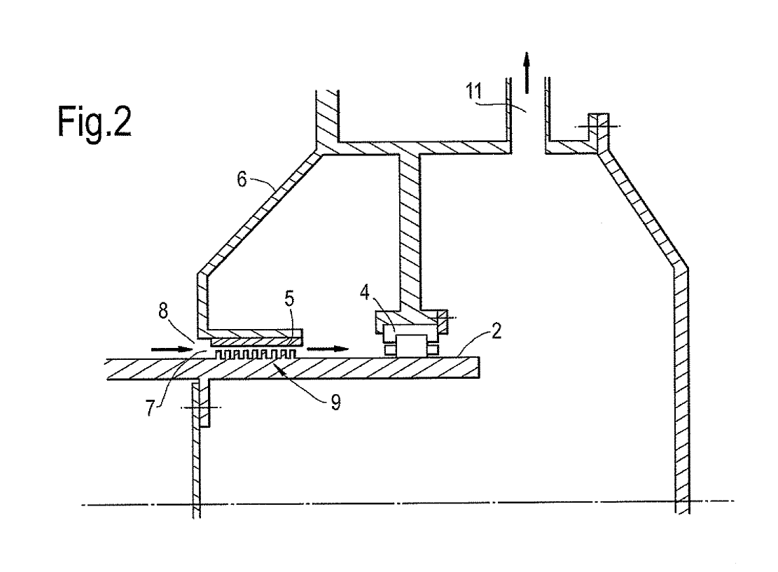

FIG. 2 is a sectional side view of a bearing chamber comprising a prior seal arrangement;

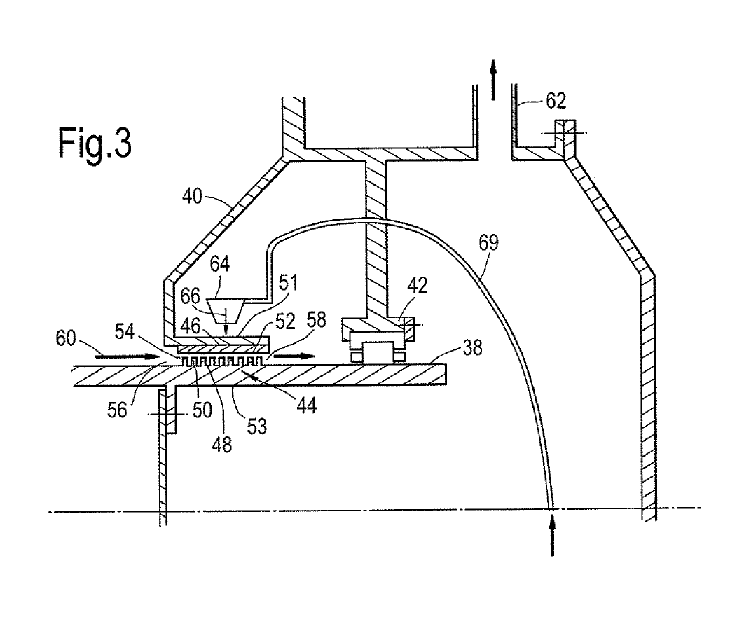

FIG. 3 is a sectional side view of a first bearing chamber including a first sealing arrangement in accordance with the present disclosure;

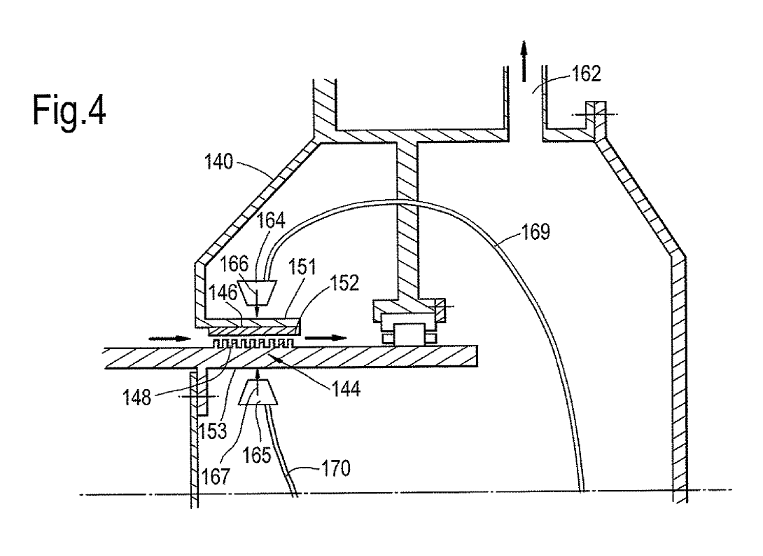

FIG. 4 is a sectional side view of a first bearing chamber including a second sealing arrangement in accordance with the present disclosure; and

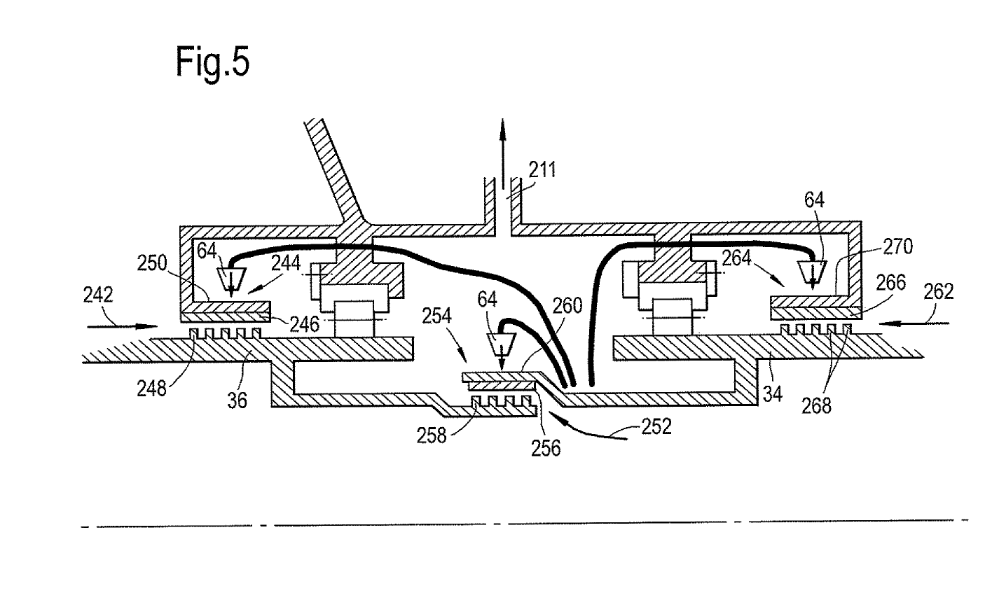

FIG. 5 is a sectional side view of part of a second bearing chamber including a third sealing arrangement in accordance with the present disclosure.

A gas turbine engine 10 is shown in FIG. 1 and comprises an air intake 12 and a propulsive fan 14 that generates two airflows A and B. The gas turbine engine 10 comprises, in axial flow in the direction A, an intermediate pressure compressor 16, a high pressure compressor 18, a combustor 20, a high pressure turbine 22, an intermediate pressure turbine 24, a low pressure turbine 26 and an exhaust nozzle 28. A nacelle 30 surrounds the gas turbine engine 10 and defines, in axial flow in the direction B, a bypass duct 32. The high pressure, intermediate pressure and low pressure compressors are each driven by respective shafts 34, 36, 38, each of which are in turn driven by a respective high, intermediate and low pressure turbine 22, 24, 26.

The gas turbine engine 10 includes a plurality of bearing chambers which surround at least one of the shafts 34, 36, 38. A bearing chamber 40 surrounding the low pressure shaft 38 and including a bearing arrangement 42 is located at a rear part of the engine, as shown in FIG. 1. Second, third and fourth bearing chambers 240, 340 and 440 surrounding each of the high, intermediate and low pressure shafts 34, 36, 38 are located within the compressor section, turbine section and front bearing housing of the engine respectively, as shown in FIG. 1. The bearing chamber 40 is shown in further detail in FIG. 3.

The bearing chamber 40 includes a first seal arrangement 44 in accordance with the present disclosure. The seal arrangement 44 comprises a seal land 46 located on an inwardly extending lip of an end of the bearing chamber 40 and extending concentrically with the low pressure shaft 38. The seal arrangement 44 also includes and a plurality of opposing non-contact seal members located on the shaft 38. The non-contact seal members are in the form of spaced fin members 48 extending generally perpendicular to the shaft. The seal members and seal land together form a labyrinth seal.

The fins 48 and seal land 46 define respective opposing sealing surfaces 50, 52. The respective sealing surfaces 50, 52 are spaced apart to define a fluid flow path 54 extending from a seal inlet 56, to a seal outlet 58. The shaft 38 and seal land also define respective non-sealing surfaces 51, 53 located on opposite sides to the sealing surfaces, such that the non-contact sealing surfaces are not in direct fluid communication with the fluid flow path 54. In use, high pressure sealing air 60 is supplied to the seal inlet 56 from a high pressure compressor 18 of the gas turbine engine 10, and flows along the flow path 60 from the seal inlet 56 to the seal outlet 58, before exiting the chamber 40 through a sealing air vent 62 located in an upper in use part of the bearing chamber 40.

The bearing chamber 40 further comprises a sealing air cooling arrangement comprising a fluid spray nozzle 64. The fluid spray nozzle is configured to supply a cooling fluid in the form of an oil jet 66 to the non-contact surface 51 of the seal land 46, i.e. on the side of the seal land which faces away from the fluid flow path. The fluid supply nozzle 64 is supplied with oil from an oil reservoir (not shown) contained within the engine oil distribution system of the gas turbine engine 10, and is supplied to the nozzle 64 by an oil pump (not shown) via a conduit 69. Alternatively, the oil could be supplied from a reservoir within the bearing chamber 40 by a pump also located within the bearing chamber 40. The oil jet 66 (which is at a lower temperature relative to the sealing air) contacts the seal land non-sealing surface 51. The relatively cool oil cools the seal land, which in turn cools the sealing air flowing through the flow path 60. The warmed oil then flows back into the bearing chamber sump, thereby removing heat from the seal land non-sealing surface 51, and solving the problem of the above mentioned related art. The quantity of oil required to cool the seal would be dependent on the particular application and operating temperature. We have found however that typical oil flow rates of around 10% to 20% of nominal chamber flow is generally required for each cooled seal surface.

A bearing chamber 140 having a second sealing arrangement 144 in accordance with the present disclosure is shown in FIG. 4.

The seal arrangement 144 comprises a seal land 146 and non-contact seal members 148, which together form a labyrinth seal similar to the arrangement of FIG. 3. The seal arrangement 144 includes a first fluid spray nozzle 164, arranged to provide a first cooling oil jet 166 to the seal land non-sealing surface 151 in use. The seal arrangement 144 also includes a second fluid spray nozzle 165 located within the shaft and configured to provide a second cooling oil jet 167 to the non-sealing surface (i.e. the annularly inner surface 153) of the shaft 138. The second nozzle 165 is also supplied with oil from the bearing chamber reservoir by a conduit 170.

The seal arrangement 144 may provide more effective cooling of the sealing air flowing through the flow path 60 in comparison to the first seal arrangement 44, as both the seal member and seal land non-sealing surfaces 151, 153 are cooled by respective oil jets 166, 167. The second oil jet 167 may be particularly effective, since the seal members have a larger total surface area in contact with the sealing air in comparison to the sealing land sealing surface 152, thereby acting as cooling fins. The seal arrangement 144 thereby also solves the problem of the related art.

FIG. 5 shows the second bearing chamber 240, and includes three sealing arrangements 244, 254, 264 each comprising respective seal lands 246, 256, 266 and sealing fins 248, 258, 268. The sealing arrangement 244 provides a seal between the wall of the bearing chamber 240 and the high pressure shaft 34, while the sealing arrangement 254 provides an intershaft seal between the high pressure 34 and intermediate pressure 36 shafts, and the sealing arrangement 264 provides a seal between the bearing chamber 240 wall and intermediate pressure shaft 36. Sealing air 242, 252, 262 is supplied to each of the sealing arrangements 244, 254, 264. Each of the seal arrangements 244, 254, 264 are similar to the sealing arrangement 44, 144 and include cooling fluid supply nozzles 64 which are arranged to provide an oil jet 64 to a respective sealing land 250, 260, 270. Each of the nozzles 64 is supplied by a respective duct from an oil reservoir of the oil distribution system.

The present disclosure provides a sealing means, bearing chamber and gas turbine engine having a number of advantages over prior arrangements. The sealing arrangement cools the high pressure sealing air, thereby permitting the use of higher pressure sealing air in comparison to the related art, from a high pressure compressor of a gas turbine engine for example. By reducing the temperature of the sealing air at the seal outlet, the arrangement also increases the longevity of the bearing chamber oil, thereby extending the maintenance interval. The cooling arrangement uses cooling fluid already available within the bearing chamber, and has low maintenance requirements. The cooling arrangement of the seal assembly also cools one or both of the seal member and seal runner non-sealing surfaces, thereby reducing thermal expansion of the seal members and runner, and leading to improved control of the seal clearance.

While the invention has been described in conjunction with the examples described above, many equivalent modifications and variations will be apparent to those skilled in the art when given this disclosure. Accordingly, the examples of the invention set forth above are considered to be illustrative and not limiting. Various changes to the described embodiment may be made without departing from the spirit and scope of the invention.

For example, the sealing arrangement could comprise other types of non-contact seals, such as leaf seals. The seal arrangement could be used to seal other types of components, such as the seals on an accessory gearbox of a gas turbine engine, where these are of the “air-blown” variety, using high pressure/temperature air. The seal arrangement could be also used for applications other than gas turbine engines, such as turbomachinery generally (such as turbochargers for reciprocating engines, or in other components of reciprocating piston engines.

1. A seal assembly, the seal assembly comprising;
a sealing land having a sealing surface and a non-sealing surface;
a non-contact seal member having a sealing surface and a non-sealing surface, the non-contact seal member being spaced apart from the sealing land sealing surface to define a fluid flow path between the seal land sealing surface and seal member sealing surface; and
a cooling arrangement comprising a fluid spray nozzle configured to provide a cooling fluid jet to one or both of the seal member and the seal runner non-sealing surfaces.

2. A seal assembly according to claim 1, in which the sealing land is provided on a lip which extends inwardly from an end part of a bearing chamber housing, and the seal member comprises a part of a shaft.

3. A seal assembly according to claim 1, in which the seal member is provided on a lip which extends inwardly from an end part of a bearing chamber housing, and the seal land comprises a part of a rotatable shaft.

4. A seal assembly according to claim 1, in which the seal member is provided on a first rotatable shaft, and the seal land is provided on a second rotatable shaft provided annularly outwardly of the first rotatable shaft.

5. A seal assembly according to claim 1, in which the seal assembly comprises a labyrinth seal.

6. A seal assembly according to claim 1, in which the cooling arrangement comprises a plurality of fluid spray nozzles.

7. A seal assembly according to claim 2, in which the cooling fluid is sourced from an oil reservoir comprising the bearing chamber.

8. A seal assembly according to claim 7, in which the cooling arrangement comprises an oil pump.

9. A bearing chamber for a gas turbine engine comprising a seal assembly according to claim 1.

10. An engine comprising a bearing chamber according to claim 9.

11. A method of cooling a sealing fluid for a non-contact seal assembly, the method comprising;
directing a cooling fluid to a non-sealing surface of one of a non-contact seal member and a seal land of the seal assembly.

12. A method according to claim 11, in which the cooling fluid comprises oil.

13. A method according to claim 12 in which the oil is sourced from a bearing chamber of a gas turbine engine.

14. A bearing chamber for a gas turbine engine comprising a seal assembly according to claim 2.

15. A bearing chamber for a gas turbine engine comprising a seal assembly according to claim 3.

16. A bearing chamber for a gas turbine engine comprising a seal assembly according to claim 4.

17. A bearing chamber for a gas turbine engine comprising a seal assembly according to claim 5.

18. A bearing chamber for a gas turbine engine comprising a seal assembly according to claim 6.

19. A bearing chamber for a gas turbine engine comprising a seal assembly according to claim 7.

20. A bearing chamber for a gas turbine engine comprising a seal assembly according to claim 8.
